(19) United States
(12) Patent Application Publication
(10) Pub. No.: US 2005/0053106 A1
(43) Pub. Date: Mar. 10, 2005

(54) Nitric oxide stimulation laser and method

(76) Inventors: Raymond W. Herron, Deltona, FL (US); Robert D. Schulz, Orange County, FL (US); Noel Bouyett, Orange County, FL (US)

Correspondence Address: RAYMOND W. HERRON, 2399 KIMBERLY DRIVE, DELTONA, FL, 32738, US

(21) Appl. No.: 10/658,388

(22) Filed: Sep. 10, 2003

(51) Int. Cl. H01S 3/00

(52) U.S. Cl. 372/38.07

(57) ABSTRACT

A nitric oxide-stimulation laser has an applicator packet (1) containing at least one diode chip (2) with dedicated emission of infrared (IR) light in wavelengths of predeterminedly proximate 1,550 nanometers for being eye safe and non-invasive with battery power for a duty cycle of one on and three off at a desired rate of repetition for operating periods of fifteen minutes with automatic shutoff. The IR laser light is generated by passing a set current current of predeterminedly proximate 160 milliamps axially through a diode chip of preferably GaInAsP/InP. From a light-emission end (14) of the diode chip, an astigmatic and non-coherent beam (12) of IR light is emitted and converted with a beam processor (10) to collimated light beams (13) for effectively deep penetrative entry into a select portion of an animate body (15) for stimulation of animate generation of nitric oxide for improvement of the animate body. Wavelength and current can be manufacturer preset for safe use by ordinary people or variable within ranges preset by the manufacturer for more comprehensive non-invasive and eye-safe use. A method includes positioning the applicator packet where intended for use on the animate body, turning it on for either a preset time for a preset embodiment or an adjusted time for an adjustable embodiment, leaving it in place until it stops automatically, and repeating the process as desired.

### BACKGROUND OF THE INVENTION

1. Field of the Invention

This invention relates to lasers for increasing nitric oxide beneath surfaces of skin and in body organs selectively by irradiation of a preset safe level of concentrated infrared light emitted from a diode laser.

2. Relation to Prior Art.

There are a wide variety of laser systems and methods for using them for non-surgical therapy. Due to controllably low thermal energy for preventing tissue damage, previously known laser systems and use methods have advantages over other non-surgical techniques. The other non-surgical techniques include ultrasonic surgery, electrical stimulation, high-frequency stimulation by diathermy, X-rays and microwave irradiation.

For controlling them safely and effectively, however, the known laser systems generally require medical or other professional skill and protocol. They have greater danger from non-professional use than from non-professional use of natural objects. They are, therefore, invasive, although less dangerous from non-professional use than other non-surgical techniques. Other known laser systems and methods exceed the threshold of being invasive. Being more dangerous without professional skill and approved protocol than non-professional use of natural objects and common public items makes other known laser systems invasive.

There is no known laser system that is eye safe and non-invasive with wide effectiveness in a manner taught by this invention. Without being more dangerous than non-professional use of natural objects by the general public, it stimulates levels of production of nitric oxide (NO) that are vital to remedial effects on nearly every pathological condition known. Pathological conditions that are remedial with the levels of NO produced safely without professional direction or protocol by this nitric oxide-stimulation laser and method include but are not limited to pain, diabetes, high blood pressure, cancer, stroke, viral disease, parasitic disease, memory disorders, learning disorders, drug addiction, sunburn, and male impotence.

Listed below for consideration is known related prior art:

| Number | Date | Inventor | U.S. Class |
|---|---|---|---|
| U.S. Pat. No. 6,084,242 | July 2000 | Brown, Jr, et al | 250/504R |
| U.S. Pat. No. 5,755,752 | May 1998 | Segal | 607/89 |
| U.S. Pat. No. 5,196,004 | March 1993 | Sinofsky | 603/3 |
| U.S. Pat. No. 4,930,504 | June 1990 | Diamantopoulos | 250/504H |
| | | et al | |
| U.S. Pat. No. 4,686,986 | August 1987 | Fenyo et al | 250/504R |

### SUMMARY OF THE INVENTION

Objects of patentable novelty and utility taught by this invention are to provide a nitric oxide-stimulation laser and method which:
is non-invasive for non-professional public use as a result of a structurally dedicated low level of infrared (IR) light emitted by a diode laser at wavelengths within a range of 1,300-to-1,600 nanometers;
includes a diode chip that irradiates infrared (IR) light which is capable of stimulating bodily production of NO without damaging organic tissue within an automatic-shutoff time of use;
achieves deep-penetration of the IR light without causing tissue damage;
directs astigmatic IR light straightly parallel into tissue for uniform a real stimulation of NO;
can be produced in multiple-diode units for application to large areas or in single-diode units for spot stimulation and moving treatment;
includes an automatic on-and-off pulsatile duty cycle that stimulates production of NO during a productively effective and safe “on” period of time that is followed by an “off” period of time that allows use of the NO by organic tissue and recuperation of the organic tissue before recurrence of the “on” period of time of the on-and-off pulsatile duty cycle;
is remedial of a large portion of pathological conditions;
can be produced inexpensively for affordable use by the general public;
can be produced with multiple diode units for professional and sophisticated, high-cost applications with increased effectiveness without being invasive and requiring professional use and protocol;
can be made variable within manufacturer-preset ranges of wavelength and current for safe ordinary and professional use; and
is isolation powered with preferably a chargeable battery for redundant safety and universal use.

This invention accomplishes these and other objectives with a nitric oxide-stimulation laser having an applicator packet containing at least one diode chip with dedicated emission of infrared (IR) light in wavelengths of predeterminedly proximate 1,550 nanometers for being eye safe and non-invasive with battery power for a duty cycle of one on and three off at a desired rate of repetition for operating periods of fifteen minutes with automatic shutoff. The IR laser light is generated by passing a set current of predeterminedly proximate 160 milliamps axially through a diode chip of preferably GaInAsP/InP. From a light-emission end of the diode chip, an astigmatic and non-coherent beam of IR light is emitted and converted with a beam processor to collimated light beams for effectively deep penetrative entry into a select portion of an animate body for stimulation of animate generation of nitric oxide for improvement of the animate body. Wavelength and current can be manufacturer preset for safe use by ordinary people or variable within ranges preset by the manufacturer for non-invasive and eye-safe ordinary and professional use. A method includes positioning the applicator packet where intended for use on the animate body, turning it on for either a preset time for a preset embodiment or an adjust time for an adjustable embodiment, leaving it in place until it stops automatically, and repeating the process as desired.

### BRIEF DESCRIPTION OF DRAWINGS

This invention is described by appended claims in relation to description of a preferred embodiment with reference to the following drawings which are explained briefly as follows:

FIG. 1 is a system diagram of this nitric oxide-stimulation laser;

FIG. 2 is a system diagram of a laser source unit having a Fresnel lens in proximity to a portion of an animate body;

FIG. 3 is a partially cutaway side view of a single-unit embodiment having a chargeable battery with a battery cord to a single diode unit having a beam processor with the Fresnel lens;

FIG. 4 is a partially cutaway top view of the FIG. 3 illustration;

FIG. 5 is a bottom view of the FIG. 3 illustration;

FIG. 6 is a top view of the FIG. 3 illustration having a timer-circuit knob;

FIG. 7 is a bottom view of a circular multiple-unit embodiment having a chargeable battery with a battery cord in communication with a plurality of diode units;

FIG. 8 is a side view of the FIG. 8 illustration having the control knob;

FIG. 9 is a bottom view of an approximately square multiple-unit embodiment having a chargeable battery with a battery cord in communication with a plurality of the diode units; 13 and for directing the collimated light beams 13 collinearly for deep penetration into an animate body 15 to stimulate animate generation of nitric oxide effectively for improving animation of the animate body 15 without invasive danger to the ordinary users.

The battery 17 can include a battery 17 that is rechargeable for reliably safe use remotely by the ordinary users.

Preferably, the predetermined level of milliamps of current is approximately 160 milliamps.

The range of emission of infrared light can include a wavelength of predeterminedly proximate 1,550 nanometers for being Class I eye safe in addition to being non-invasive.

The infrared light in wavelengths of predeterminedly proximate 1,550 nanometers can include the infrared light in a wavelength within a range of 1,580-to-1,520 nanometers.

The infrared light in wavelengths of predeterminedly proximate 1,550 nanometers can include the infrared light in a wavelength within the range of 1,300-to-1,600 nanometers.

The diode chip 2 can include a GaInAsP/InP diode chip.

The timer switch 4 is articulated for being reset by turning on power to the diode chip 2 manually with a push-button switch 18 for restarting successive operating periods selectively.

The timer switch 4 can include a timer switch 4 that is preset for a fifteen-minute operating period.

The timer switch 4 can include a timer circuit 16 that is articulated for being adjusted for selected operating periods within a predetermined range of time of the operating periods for reliably safe use by predeterminedly knowledgeable and skilled

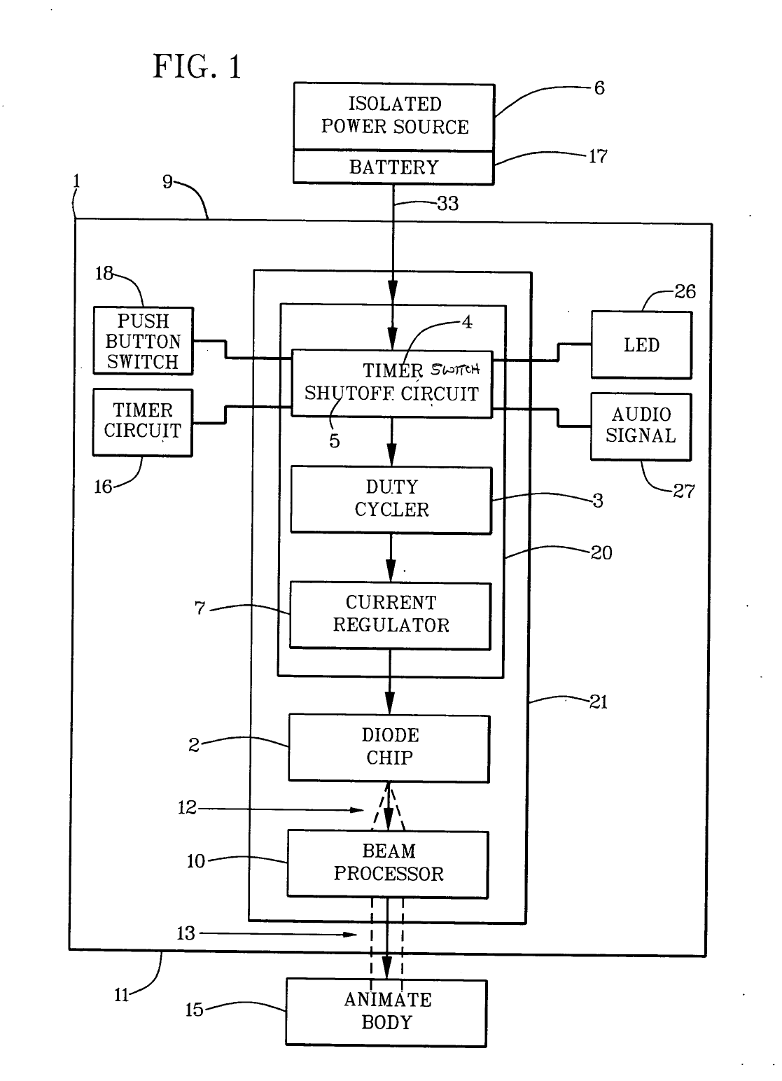

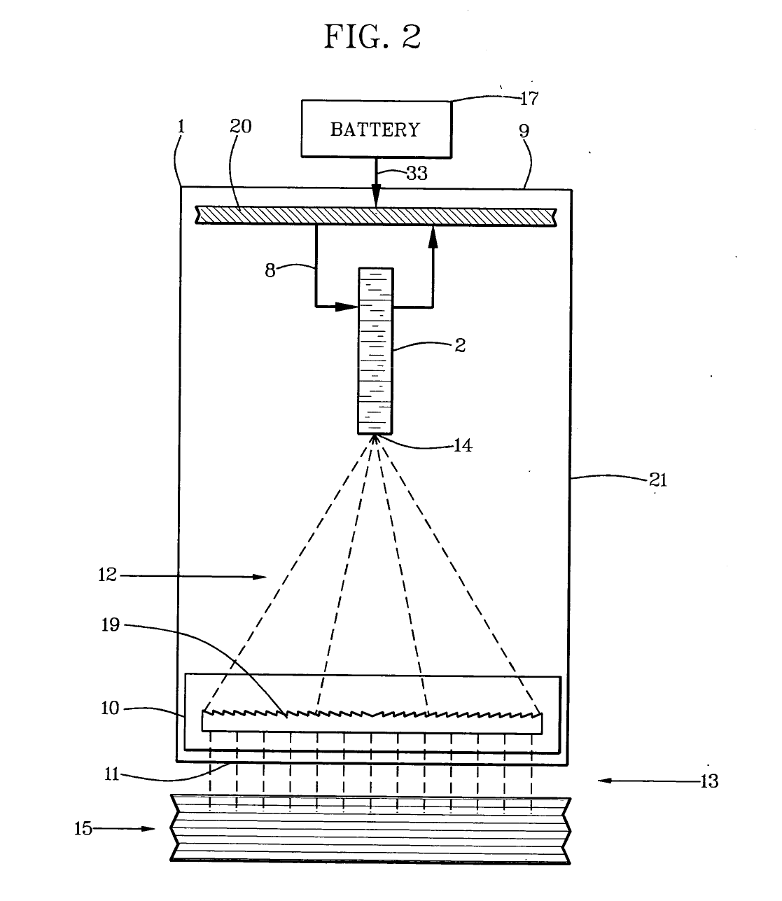

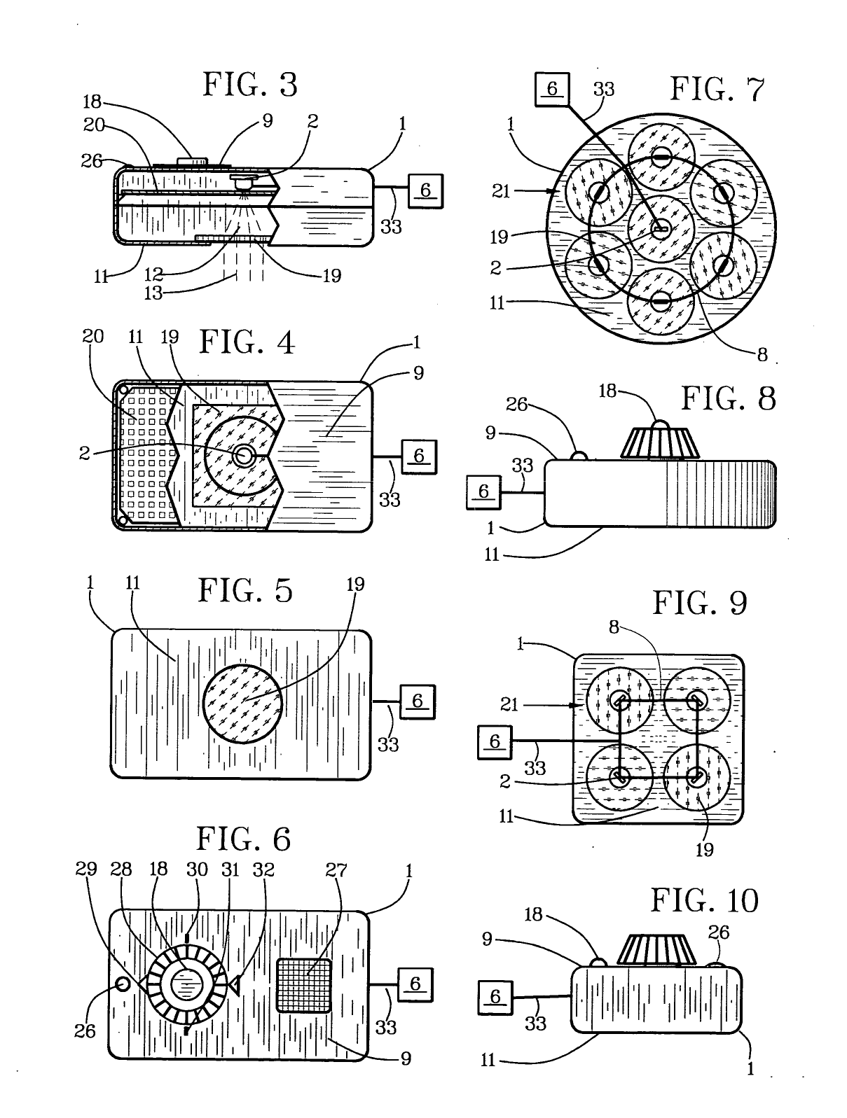

Referring to FIGS. 1-6, a nitric oxide-stimulation laser has an applicator packet 1 containing at least one predetermined diode chip 2 having a manufacturer-preset level of emission of infrared light in predetermined wavelengths within the range of 1,300-to-1,600 nanometers for eye-safe and non-invasive use by ordinary users. A duty cycler 3 is in electrical communication with a current-input side of the diode chip 2. The duty cycler 3 has a duty-cycle ratio of twenty-five percent on and seventy-five percent off at the predetermined rate of repetition.

A timer switch 4 having a timer circuit 16 with the automatic shutoff circuit 5 is in electrical communication with the duty cycler 3. An isolated power source 6, that can include a battery 17 having the predeterminedly safe level of electrical power is in electrical communication with the timer switch 4.

A push-button switch 18 is employed for turning power on from the battery 17, or other isolated power source 6, to the timer switch 4 for starting the manufacturer-preset timing for automatic shutoff by the automatic shutoff circuit 5 for non-invasive and eye-safe use by ordinary users.

Input current is regulated by a current regulator 7 intermediate the isolated power source 6 and the current-input side of the diode chip 2.

A current conductor 8 passes a predetermined level of milliamps of current from the current regulator 7 through the diode chip 2 during the on cycles of the duty cycler 3.

The diode chip 2 is positioned predeterminedly proximate an inside surface of a proximal side 9 of the applicator packet 1.

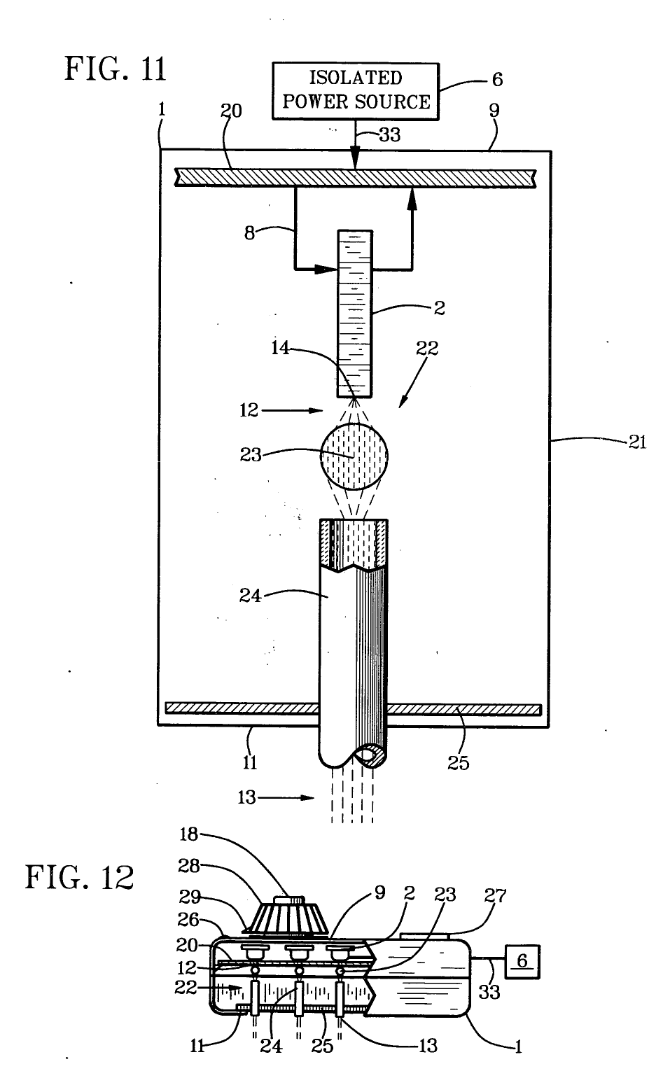

At least one beam processor 10 is positioned intermediate a light-emission end 14 of the diode chip 2 and a distal side 11 of the applicator packet 1 for converting astigmatic light beams 12 of the infrared light into designedly collimated light beams FIG. 10 is a side view of the FIG. 9 illustration with the timer-circuit knob;

FIG. 11 is a system diagram of a chip unit having a fiber-optic collimator; and

FIG. 12 is a side view of a multiple-unit embodiment having a plurality of fiber-optic collimators and a timer-circuit knob for variable control of time and current input.

### DESCRIPTION OF PREFERRED EMBODIMENT

Listed numerically below with reference to the drawings are terms used to describe features of this invention. These terms and numbers assigned to them designate the same features throughout this description.

```
  1. Applicator packet
  2. Diode chip
  3. Duty cycler
  4. Timer switch
  5. Shutoff circuit
  6. Isolated power source
  7. Current regulator
  8. Current conductor
  9. Proximal side
10. Beam processor
11. Distal side
12. Astigmatic light beams
13. Collimated light beams
14. Light-emission end
15. Animate body
16. Timer circuit
17. Batteiy
18. Push-button switch
19. Fresnel lens
20. Control board
21. Laser source unit
22. Fiber optic coupler
23. Convergence ball lens
24. Jacketed glass fiber
25. Protective cover
26. LED
27. Audio signaler
28. Timer circuit knob
29. Control pointer
30. Half-high mark
31. Half-low mark
32. Controller stop
33. Electrical cord
```

users.

The beam processor 10 can include a predeterminedly positive lens positioned parallel to proximate the distal side 11 of the applicator packet 1. The positive lens can include a Fresnel lens 19.

The applicator packet 1 can include a plurality of the diode chips 2 and the timer switch 4 can be in electrical communication with the plurality of the diode chips 2 through the current conductor 8. The beam collimator can include the Fresnel lens 19 having a focal length of predeterminedly proximate 0.6 inches. The Fresnel lens 19 is affixed to the distal side 11 predeterminedly proximate 0.6 inches from the light-emission end 14 of the diode chip 2 and the Fresnel lens 19 has a lens axis that is collinear to the diode axis. The beam processor 10 can include a plurality of beam collimators with one beam collimator for each of a plurality of laser source units with the beams of infrared light for straightening differing angles of the beam divergence of each of the beams of infrared light into parallelism with the diode axis and into perpendicularity to the animate body 15.

The timer switch 4, the duty cycler 3 and the current regulator 7 are positioned on a control board 20 for control communication with one or more laser source units 21 which include the diode chip 2 and the beam processor 10.

The beam processor 10 can include a fiber optic collimator 22 having a convergence ball 23, which is generally a glass ball that diverges and converges light, intermediate the diode chip 2 and a jacketed glass fiber 24. The fiber optic collimator 22 is positioned proximate an inside periphery of the distal side 11 of the applicator packet 1 and has an axis that is collinear to the diode axis.

The applicator packet 1 can include a plurality of the laser source units 21 of nitric oxide-stimulation laser shaving the diode chips 2 with the fiber-optic collimators 22 and the timer switch 4 being in electrical communication with the plurality of the laser source units 21.

The plurality of the laser source units 21 of nitric oxide-stimulation lasers having the diode chips 2 with the fiber-optic beam collimators 22 are spaced approximately one-quarter-to-three-quarters of an inch apart proximate an insider periphery of the proximal side 9 of the applicator packet 1. A protective cover 25 can be positioned proximate an inside periphery of the distal side 11 of the applicator packet 1. The laser source units 21 with the fiber-optic collimators 22 are oriented and positioned to direct collimated light beams 13 through the protective cover 25. The applicator packet 1 can include a visual signaler of operating status of the timer switch 4.

The visual signaler can include an LED 26 in electrical communication with the timer switch 4.

The applicator packet 1 can include an audio signaler 27 of operating status of the timer 4 and the visual signaler can include the LED 26 in electrical communication with the timer switch 4.

Referring to FIGS. 1-12, an embodiment for more professional and yet eye-safe and non-invasive use, the applicator packet 1 can contain at least one predetermined diode chip 2 having a manufacturer-preset level of control of emission of infrared light in predetermined wavelengths greater and lesser than the range of 1,300-to-1,600 nanometers. The duty cycler 3 is in electrical communication with the current-input side of the diode chip 2 with the duty cycler 3 having the duty-cycle ratio of twenty-five percent on and seventy-five percent off at the predetermined rate of repetition.

The timer switch 4 has the timer circuit 16 with the automatic shutoff circuit 5 in electrical communication with the duty cycler 3 with the timer circuit 16 being a controller for setting operational time periods for automatic shutoff with the automatic shutoff circuit 5. The wavelengths are controlled automatically in accordance with the manufacturer-preset of emission of infrared light in predetermined wavelengths greater and lesser than the range of 1,300-to-1,600 nanometers.

The isolated power source 6 has the predeterminedly safe level of electrical power in electrical communication with the timer switch 4. A push-button switch 18 is provided for turning power on from the isolated power source 6 to the timer switch 4.

The current regulator 7 is intermediate the isolated power source 6 and the current-input side of the diode chip 2.

The current conductor 8 passes the predetermined level of milliamps of current from the current regulator 7 through the diode chip 2 during the on cycles of the duty cycler 3. The predetermined level of milliamps of current for being passed from the current regulator 7 through the diode chip 2 during the on cycles of the duty cycler 3 is manufacturer preset in predetermined proportion to the manufacturer-preset level of control of emission of infrared light in wavelengths greater and lesser than the range of 1,300-to-1,600 nanometers.

The diode chip 2 is positioned predeterminedly proximate the inside surface of the proximal side 9 of the applicator packet 1. At least one beam processor 10 is positioned intermediate the light-emission end 14 of the diode chip 2 and the distal side 11 of the applicator packet 1 for converting astigmatic light beams 12 of the infrared light into designedly collimated light beams 13 and for directing the collimated light beams 13 collinearly for deep penetration into the animate body 15 to stimulate animate generation of nitric oxide effectively for improving animation of the animate body 15 without invasive danger to the ordinary users.

The controller for setting operational time periods for automatic shutoff with the automatic shutoff circuit 5 through the timer circuit 16 can include a timer circuit knob 28. The timer circuit knob 28 can include a control pointer 29 for pointing to a half-high mark 30 proximate the applicator packet 1 in a time-increase direction of rotation, for pointing to a half-low mark 31 proximate the applicator packet 1 in a time-decrease direction of rotation, and for encountering a controller stop 32 at a maximum of time-increase and time-decrease rotation.

The beam processor 10 can include a predeterminedly positive lens positioned parallel to proximate the distal side 11 of the applicator packet 1. The positive lens can include the Fresnel lens 19.

The applicator packet 1 can include a plurality of the diode chips 2 with the timer switch 4 being in electrical communication with the plurality of the diode chips 2 through the current conductor 8.

The beam collimator can include the Fresnel lens 19 having the focal length of predeterminedly proximate 0.6 inches. The Fresnel lens 19 is affixed to the distal side 11 predeterminedly proximate 0.6 inches from the light-emission end 14 of the diode chip 2 and the Fresnel lens 19 has a lens axis that is collinear to the diode axis.

The beam processor 10 can include the plurality of beam collimators with one beam collimator for each of the plurality of the beams of infrared light for straightening differing angles of the beam divergence of each of the beams of infrared light into parallelism with the diode axis and into perpendicularity to the animate body 15 for stimulation with the plurality of the beams of infrared light.

The plurality of the beam collimators can include a plurality of Fresnel lenses 19 with each of the plurality the Fresnel lenses 19 having a focal length of predeterminedly proximate 0.6 inches with the plurality of the Fresnel lenses 19 affixed to the distal side 11 of the applicator packet 1 predeterminedly proximate 0.6 inches from the light-emission end 14 of the diode chip 2. The Fresnel lenses 19 each have a lens axis that is collinear to the diode axis of each of the plurality of the diode chips 2.

The timer switch 4, the duty cycler 3 and the current regulator 7 are positioned on the control board 20 for control communication with one or more laser source units 21 which include the diode chip 2 and the beam processor 10.

The beam processor 10 can include the fiber-optic collimator 22 having the convergence ball 23 intermediate the diode chip 2 and a jacketed glass fiber 24. The fiber-optic collimator 22 is positioned proximate an inside periphery of the distal side 11 of the applicator packet 1 with the fiber-optic collimator 22 having an axis that is collinear to the diode axis.

The applicator packet 1 can include a plurality of the laser source units 21 of nitric oxide-stimulation lasers having the diode chips 2 with the fiber-optic collimators 22 and the timer switch 4 being in electrical communication with the plurality of the laser units 21.

The plurality of the chip units of nitric oxide-stimulation lasers have the diode chips 2 with the fiber-optic beam collimators 22 being spaced approximately one-quarter-to-three-quarters of an inch apart proximate an insider periphery of the proximal side 9 of the applicator packet 1. A protective cover 25 can be positioned proximate an inside periphery of the distal side 11 of the applicator packet 1. The laser source units 21 with the fiber-optic collimators 22 are oriented and positioned to direct collimated light beams 13 through the protective cover 25.

The applicator packet 1 can include the visual signaler of operating status of the timer switch 4. The visual signaler can include the LED 26 in electrical communication with the timer switch 4. The applicator packet 1 can include the audio signaler 27 of operating status of the timer switch 4 and the visual signaler can include the LED 26 in electrical communication with the timer switch 4.

A method has the following steps for using the nitric oxide-stimulation laser of claim 2:
positioning the applicator packet 1 with the beam processor 10 in desired proximity to a desired portion of an animate body 15;
setting the timer switch 4;
allowing the beam processor 10 to be in the desired proximity to the desired portion of the animate body 15 for a predetermined period of time that the timer is set to operate before being shut off automatically by the automatic-shutoff switch; and
removing the beam processor from the desired proximity to the desired portion of the animate body.

The method can further comprise:
repositioning the beam processor 10 of the applicator packet 1 on a subsequently desired portion of the animate body 15;
resetting the timer switch 4;
allowing the beam processor 10 to be in the desired proximity to the subsequently desired portion of the animate body 15 for a predetermined period of time that the timer switch 4 is reset to operate before being shut off automatically by the automatic-shutoff switch; and
removing the beam processor 10 of the applicator packet 1 from the desired proximity to the subsequently desired portion of the animate body 15 repeatedly as desired.

The same method with a slight modification can be used for the nitric oxide-stimulation laser of claims 26-44. The slight modification being adjusting the timer switch 4 with the timer circuit knob 28 which automatically adjusts current to preset safe levels for safe use by ordinary users, but requires higher cost for the unit and, therefore, may be used more by clinics and professional personnel.

The nitric oxide-stimulation laser preferably includes an electrical cord 33 from the isolated power source 6, which can include a preferably chargeable battery 17, to the control board 20 for communicating current to the timer switch 4.

A new and useful nitric oxide-stimulation laser and method having been described, all such foreseeable modifications, adaptations, substitutions of equivalents, mathematical possibilities of combinations of parts, pluralities of parts, applications, forms and methods thereto as described by the following claims and not precluded by prior art are included in this invention.

1. A nitric oxide-stimulation laser comprising:
an applicator packet containing at least one predetermined diode chip having a predeterminedly fixed level of emission of infrared light in predetermined wavelengths within a range of 1,300-to-1,600 nanometers for eye-safe and non-invasive use by ordinary users;
a duty cycler in electrical communication with a current-input side of the diode chip;
the duty cycler having a duty-cycle ratio of twenty-five percent on and seventy-five percent off at a predetermined rate of repetition;
a timer having a timer circuit with an automatic shutoff circuit in electrical communication with the duty cycler;
an isolated power source having a predeterminedly safe level of electrical power in electrical communication with the timer;
a current regulator intermediate the isolated power source and the current-input side of the diode chip;
a current conductor for passing a predetermined level of milliamps of current from the current regulator through the diode chip during the on cycles of the duty cycler;
the diode chip being positioned predeterminedly proximate an inside surface of a proximal side of the applicator packet; and
at least one beam processor positioned intermediate a light-emission end of the diode chip and a distal side of the applicator packet for converting astigmatic light beams of the infrared light into designedly collimated light beams and for directing the collimated light beams collinearly for deep penetration into an animate body to stimulate animate generation of nitric oxide effectively for improving animation of the animate body.

2. A nitric oxide-stimulation laser comprising:
the applicator packet containing at least one predetermined diode chip having a manufacturer-preset level of emission of infrared light in predetermined wavelengths within the range of 1,300-to-1,600 nanometers;
the duty cycler in electrical communication with the current-input side of the diode chip;
the duty cycler having the duty-cycle ratio of twenty-five percent on and seventy-five percent off at the predetermined rate of repetition;
the timer having the timer circuit with the automatic shutoff circuit in electrical communication with the duty cycler;
the isolated power source that includes a battery having the predeterminedly safe level of electrical power in electrical communication with the timer;
a push-button switch for turning power on from the battery to the timer for starting manufacturer-preset timing for automatic shutoff by the automatic shutoff circuit for non-invasive, eye-safe use by ordinary users;
the current regulator intermediate the isolated power source and the current-input side of the diode chip;
the current conductor for passing the predetermined level of milliamps of current from the current regulator through the diode chip during the on cycles of the duty cycler;
the diode chip being positioned predeterminedly proximate the inside surface of the proximal side of the applicator packet; and
at least one beam processor positioned intermediate the light-emission end of the diode chip and the distal side of the applicator packet for converting astigmatic light beams of the infrared light into designedly collimated light beams and for directing the collimated light beams collinearly for deep penetration into the animate body to stimulate animate generation of nitric oxide effectively for improving animation of the animate body without invasive danger to the ordinary users.

3. The nitric oxide-stimulation laser of claim 2 wherein:
the battery includes a battery that is rechargeable for reliably safe use remotely by the ordinary users.

3. The nitric oxide-stimulation laser of claim 2 wherein:
the predetermined level of milliamps of current is approximately 160 milliamps.

4. The nitric oxide-stimulation laser of claim 2 wherein:
the range of emission of infrared light includes a wavelength of predeterminedly proximate 1,550 nanometers for being Class I eye safe.

5. The nitric oxide-stimulation laser of claim 4 wherein:
the infrared light in wavelengths of predeterminedly proximate 1,550 nanometers includes the infrared light in a wavelength within a range of 1,580-to-1,520 nanometers.

6. The nitric oxide-stimulation laser of claim 4 wherein:
the infrared light in wavelengths of predeterminedly proximate 1,550 nanometers includes the infrared light in a wavelength within a range of 1,300-to-1,600 nanometers.

7. The nitric oxide-stimulation laser of claim 2 wherein:
the diode chip includes a GaInAsP/InP diode chip.

8. The nitric oxide-stimulation laser of claim 2 wherein:
the timer is articulated for being reset by turning on power to the diode chip manually with the push-button switch for restarting successive operating periods selectively.

9. The nitric oxide-stimulation laser of claim 8 wherein:
the timer includes a timer that is preset for a fifteen-minute operating period.

10. The nitric oxide-stimulation laser of claim 2 wherein:
the timer includes a timer circuit that is articulated for being adjusted for selected operating periods within a predetermined range of time of the operating periods for reliably safe use by predeterminedly knowledgeable and skilled users.

12. The nitric oxide-stimulation laser of claim 2 wherein:
the beam processor includes a predeterminedly positive lens positioned parallel to proximate the distal side of the applicator packet.

13. The nitric oxide-stimulation laser of claim 2 wherein:
the positive lens includes a Fresnel lens.

14. The nitric oxide-stimulation laser of claim 2 wherein:
the applicator packet includes a plurality of the diode chips; and
the timer is in electrical communication with the plurality of the diode chips through the current conductor.

15. The nitric oxide-stimulation laser of claim 14 wherein:
the beam collimator includes the Fresnel lens having a focal length of predeterminedly proximate 0.6 inches;
the Fresnel lens is affixed to the distal side predeterminedly proximate 0.6 inches from the light-emission end of the diode chip; and
the Fresnel lens has a lens axis that is predeterminedly collinear to the diode axis.

16. The nitric oxide-stimulation laser of claim 15 wherein:
the beam processor includes a plurality of beam collimators with one beam collimator for each of the plurality of the beams of infrared light for straightening differing angles of the beam divergence of each of the beams of infrared light into parallelism with the diode axis and into perpendicularity to a body part for stimulation with the plurality of the beams of infrared light.

17. The nitric oxide-stimulation laser of claim 16 wherein:
the plurality of the beam collimators includes a plurality of Fresnel lenses with each of the plurality the Fresnel lenses having a focal length of predeterminedly proximate 0.6 inches;
the plurality of the Fresnel lenses are affixed to the distal side of the applicator packet predeterminedly proximate 0.6 inches from the light-emission end of the diode chip; and
the Fresnel lenses each have a lens axis that is predeterminedly collinear to the diode axis of each of the plurality of the diode chips.

18. The nitric oxide-stimulation laser of claim 2 wherein:
the timer, the duty cycler and the current regulator are positioned on a control board for control communication with one or more chip units which include the diode chip and the beam processor.

19. The nitric oxide-stimulation laser of claim 2 wherein:
the beam processor includes a fiber-optic collimator having a convergence ball intermediate the diode chip and a jacketed glass fiber;
the fiber-optic collimator is positioned proximate an inside periphery of the distal side of the applicator packet; and
the fiber-optic collimator has an axis that is predeterminedly collinear to the diode axis.

20. The nitric oxide-stimulation laser of claim 19 wherein:
the applicator packet includes a plurality of the chip units of nitric oxide-stimulation lasers having the diode chips with the fiber-optic collimators; and
the timer is in electrical communication with the plurality of the chip units.

21. The nitric oxide-stimulation laser of claim 20 wherein:
the plurality of the chip units of nitric oxide-stimulation lasers having the diode chips with the fiber-optic beam collimators are spaced approximately one-quarter-to-three-quarters of an inch apart proximate an insider periphery of the proximal side of the applicator packet;
a protective lens is positioned proximate an inside periphery of the distal side of the applicator packet; and
the laser source units with the fiber-optic couplers are oriented and positioned to direct collimated light beams through the protective cover.

22. The nitric oxide-stimulation laser of claim 2 wherein:
the applicator packet includes a visual signaler of operating status of the timer.

23. The nitric oxide-stimulation laser of claim 22 wherein:
the visual signaler includes an LED in electrical communication with the timer.

24. The nitric oxide-stimulation laser of claim 2 wherein:
the applicator packet includes an audio signaler of operating status of the timer.

25. The nitric oxide-stimulation laser of claim 24 wherein:
the visual signaler includes an LED in electrical communication with the timer.

26. A nitric oxide-stimulation laser comprising:
the applicator packet containing at least one predetermined diode chip having a manufacturer-preset level of control of emission of infrared light in predetermined wavelengths greater and lesser than the range of 1,300-to-1,600 nanometers selectively;
the duty cycler in electrical communication with the current-input side of the diode chip;
the duty cycler having the duty-cycle ratio of twenty-five percent on and seventy-five percent off at the predetermined rate of repetition;
the timer having the timer circuit with the automatic shutoff circuit in electrical communication with the duty cycler;
the timer circuit being a controller for setting operational time periods for automatic shutoff with the automatic shutoff circuit;
the wavelengths being controlled automatically in accordance with the manufacturer-preset level of control of emission of infrared light in predetermined wavelengths greater and lesser than the range of 1,300-to-1,600 nanometers;
the isolated power source having the predeterminedly safe level of electrical power in electrical communication with the timer;
a push-button switch for turning power on from the isolated power source to the timer;
the current regulator intermediate the isolated power source and the current-input side of the diode chip;
the current conductor for passing the predetermined level of milliamps of current from the current regulator through the diode chip during the on cycles of the duty cycler;
the predetermined level of milliamps of current for being passed from the current regulator through the diode chip during the on cycles of the duty cycler being manufacturer preset in predetermined proportion to the manufacturer-preset level of control of emission of infrared light in wavelengths greater and lesser than the range of 1,300-to-1,600 nanometers;
the diode chip being positioned predeterminedly proximate the inside surface of the proximal side of the applicator packet; and
at least one beam processor positioned intermediate the light-emission end of the diode chip and the distal side of the applicator packet for converting astigmatic light beams of the infrared light into designedly collimated light beams and for directing the collimated light beams collinearly for deep penetration into the animate body to stimulate animate generation of nitric oxide effectively for improving animation of the animate body without invasive danger to the ordinary users.

27. The nitric oxide-stimulation laser of claim 26 wherein:
the controller for setting operational time periods for automatic shutoff with the automatic shutoff circuit through the timer circuit includes a timer circuit knob.

28. The nitric oxide-stimulation laser of claim 27 wherein:
the timer circuit knob includes a control pointer for indicating rotational positioning in relation to a half-high mark proximate the applicator packet in a time-increase direction of rotation, for indicating rotational positioning in relation to a half-low mark proximate the applicator packet in a time-decrease direction of rotation, and for encountering a controller stop at a maximum of time-increase and time-decrease rotation.

29. The nitric oxide-stimulation laser of claim 28 wherein:
the beam processor includes a predeterminedly positive lens positioned parallel to proximate the distal side of the applicator packet.

30. The nitric oxide-stimulation laser of claim 28 wherein:
the positive lens includes a Fresnel lens 19.

31. The nitric oxide-stimulation laser of claim 28 wherein:
the applicator packet includes a plurality of the diode chips; and
the timer is in electrical communication with the plurality of the diode chips through the current conductor.

32. The nitric oxide-stimulation laser of claim 31 wherein:
the beam collimator includes the Fresnel lens having a focal length of predeterminedly proximate 0.6 inches;
the Fresnel lens is affixed to the distal side predeterminedly proximate 0.6 inches from the light-emission end of the diode chip; and
the Fresnel lens has a lens axis that is predeterminedly collinear to the diode axis.

33. The nitric oxide-stimulation laser of claim 32 wherein:
the beam processor includes a plurality of beam collimators with one beam collimator for each of the plurality of the beams of infrared light for straightening differing angles of the beam divergence of each of the beams of infrared light into parallelism with the diode axis and into perpendicularity to a body part for stimulation with the plurality of the beams of infrared light.

34. The nitric oxide-stimulation laser of claim 33 wherein:
the plurality of the beam collimators includes a plurality of Fresnel lenses with each of the plurality the Fresnel lenses having a focal length of predeterminedly proximate 0.6 inches;
the plurality of the Fresnel lenses are affixed to the distal side of the applicator packet predeterminedly proximate 0.6 inches from the light-emission end of the diode chip; and
the Fresnel lenses each have a lens axis that is predeterminedly collinear to the diode axis of each of the plurality of the diode chips.

35. The nitric oxide-stimulation laser of claim 28 wherein:
the timer, the duty cycler and the current regulator are positioned on a control board for control communication with one or more laser source units which include the diode chip and the beam processor.

36. The nitric oxide-stimulation laser of claim 28 wherein:
the beam processor includes a fiber-optic coupler having a convergence ball intermediate the diode chip and a jacketed glass fiber;
the fiber-optic coupler is positioned proximate an inside periphery of the distal side of the applicator packet; and
the fiber-optic coupler has an axis that is predeterminedly collinear to the diode axis.

37. The nitric oxide-stimulation laser of claim 36 wherein:
the applicator packet includes a plurality of the laser source units of nitric oxide-stimulation lasers having the diode chips with the fiber-optic couplers; and
the timer is in electrical communication with the plurality of the chip units.

38. The nitric oxide-stimulation laser of claim 37 wherein:
the plurality of the laser source units of nitric oxide-stimulation lasers having the diode chips with the fiber-optic beam couplers are spaced predeterminedly one-quarter-to-one inch apart proximate an insider periphery of the proximal side of the applicator packet;
a protective cover is positioned proximate an inside periphery of the distal side of the applicator packet; and
the chip units with the fiber-optic couplers are oriented and positioned to direct collimated light beams through the protective cover.

39. The nitric oxide-stimulation laser of claim 28 wherein:
the applicator packet includes a visual signaler of operating status of the timer.

40. The nitric oxide-stimulation laser of claim 39 wherein:
the visual signaler includes an LED in electrical communication with the timer.

41. The nitric oxide-stimulation laser of claim 28 wherein:
the applicator packet includes an audio signaler of operating status of the timer.

42. The nitric oxide-stimulation laser of claim 41 wherein:
the visual signaler includes an LED in electrical communication with the timer.

43. A method comprising the following steps for using the nitric oxide-stimulation laser of claim 2:
positioning the applicator packet with the beam processor in desired proximity to a desired portion of an animate body;
setting the timer;
allowing the beam processor to be in the desired proximity to the desired portion of the animate body for a predetermined period of time that the timer is set to operate before being shut off automatically by the automatic-shutoff switch; and
removing the beam processor from the desired proximity to the desired portion of the animate body.

44. The method claim 43 and further comprising:
repositioning the beam processor of the applicator packet on a subsequently desired portion of the animate body;
resetting the timer;
allowing the beam processor to be in the desired proximity to the subsequently desired portion of the animate body for a predetermined period of time that the timer is reset to operate before being shut off automatically by the automatic-shutoff switch; and
removing the beam processor of the applicator packet from the desired proximity to the subsequently desired portion of the animate body repeatedly as desired.

45. The nitric oxide-stimulation laser of claim 1 and further comprising:
an electrical cord from the isolated power source to the control board for communicating current to the timer

46. The nitric oxide-stimulation laser of claim 2 and further comprising:
the electrical cord from the isolated power source to the control board for communicating current to the timer.

47. The nitric oxide-stimulation laser of claim 26 and further comprising:
the electrical cord from the isolated power source to the control board for communicating current to the timer.
